(19) United States
(12) Patent Application Publication
(10) Pub. No.: US 2007/0249202 A1
(43) Pub. Date: Oct. 25, 2007

(54) Card connector

(75) Inventor: Chien-Jen Ting, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/789,139

(22) Filed: Apr. 24, 2007

(30) Foreign Application Priority Data
Apr. 24, 2006 (TW) 95114511

(51) Int. Cl. H01R 13/62

(52) U.S. Cl. 439/159

(57) ABSTRACT

A card connector in accordance with the present invention comprises an insulating housing defining a card receiving space, a plurality of signal contacts retained in the insulating housing for electrically connecting with the card, a shell shielding the insulating housing and having a top wall and a switch contact. The switch contact is pressed upwardly by the card inserted into the card receiving space, and electrically contacts with the top wall of the shell.

### BACKGROUND OF THE INVENTION

1. Field of the Invention

The present invention is generally related to a card connector, and especially to a card connector which is used for consuming products such as digital cameras or the like.

2. Description of Related Art

An IC card is loaded into an IC card connector device to write and read necessary information. Generally, an IC card is provided with an identifier which indicates write inhibit, while the IC card connector device side is provided with a detector switch for detecting the insertion of the IC card and a detector switch (a write protect switch) for identifying IC card write inhibit. In the conventional IC card connector device, when the IC card provided with such an identifier is to be loaded therein, a detector switch having elongated lead terminals disposed opposedly to each other with contacts formed at tips of the lead terminals is disposed at a position corresponding to the identifier of the IC card which indicates write inhibit, and the contacts of the detector switch are opened and closed correspondingly to the identifier of the IC card as the IC card is inserted, thereby detecting whether write into the IC card is possible or not.

U.S. Pat. No. 6,767,232 discloses a card connector comprising an insulative housing, a plurality of terminals received in the housing, a shell shielding the housing, and a first and a second switch contacts set in one of a side wall of the housing for write-protect and full insertion detection for an electrical card. The shell has a generally planar top wall and a pad extending downwardly from one side of the top wall. An electrical card is inserted into the receptacle portion and pushes the first and the second switch contacts outwardly to electrically connect with the pad of the shell. However, the first and the second switch contacts have complex configurations that will increase a manufacture cost and assembly process of the card connector, and if the pad is break off during transmission, the first and the second switch contact will lose detecting function.

Hence, an improved card connector is highly desired to overcome the aforementioned disadvantages of the prior art.

### SUMMARY OF THE INVENTION

Accordingly, an object of the present invention is to provide a card connector, which has a locking member for locking the card completely inserted into the card connector.

To achieve the above object, a card connector in accordance with the present invention comprises an insulating housing defining a card receiving space, a plurality of signal contacts retained in the insulating housing for electrically connecting with the card, a shell shielding the insulating housing and a switch contact. The switch contact has a retaining portion secured in the insulating housing, a spring portion extending from the retaining portion into the card receiving space and a contacting portion, the spring portion with the contacting portion is pressed upwardly by the card inserted into the card receiving space, and the contacting portion electrically contacts with a top wall of the shell.

Other objects, advantages and novel features of the present invention will be drawn from the following detailed description of a preferred embodiment of the present invention with attached drawings:

### BRIEF DESCRIPTION OF THE DRAWINGS

FIG. 1 is an assembled, perspective view of a card connector in accordance with the present invention;

FIG. 2 is an exploded, perspective view of the card connector shown in FIG. 1;

FIG. 3 is a partially assembled, perspective view of the card connector in accordance with the present invention, without a shell;

FIG. 4 is a perspective view of an insulating housing of the card connector in accordance with the present invention;

FIG. 5 is a perspective view of a locking member of the card connector in accordance with the present invention;

FIG. 6 is a cutaway view of the card connector with a card, wherein the locking member engages the card; and

FIG. 7 is a perspective view of the locking member and the ejector with the card.

### DETAILED DESCRIPTION OF THE INVENTION

Reference will now be made in detail to the preferred embodiment of the present invention.

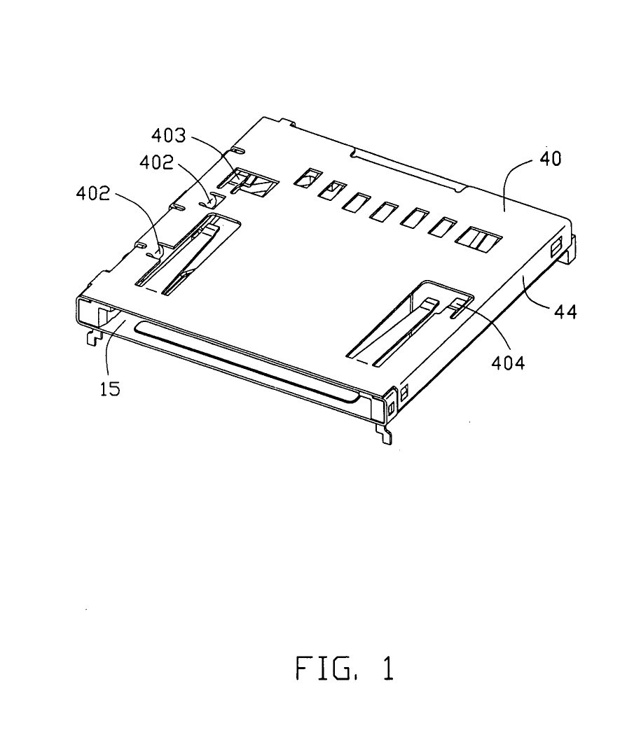

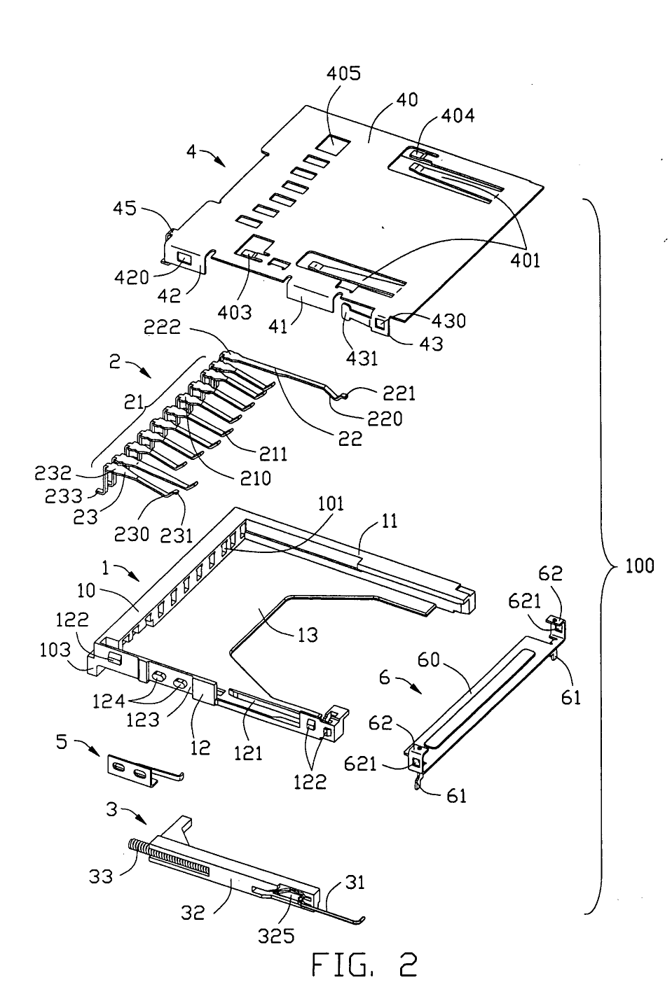

Referring to FIGS. 1 to 2, the card connector 100 in accordance with the present invention is used to connect a card 7 to a print circuit board (not shown). The card connector 100 comprises an insulating housing 1, a plurality of contacts 2 received in the insulating housing 1, an ejector 3, a shell 4 covering the insulating housing 1, a locking member 5 and a supporting board 6.

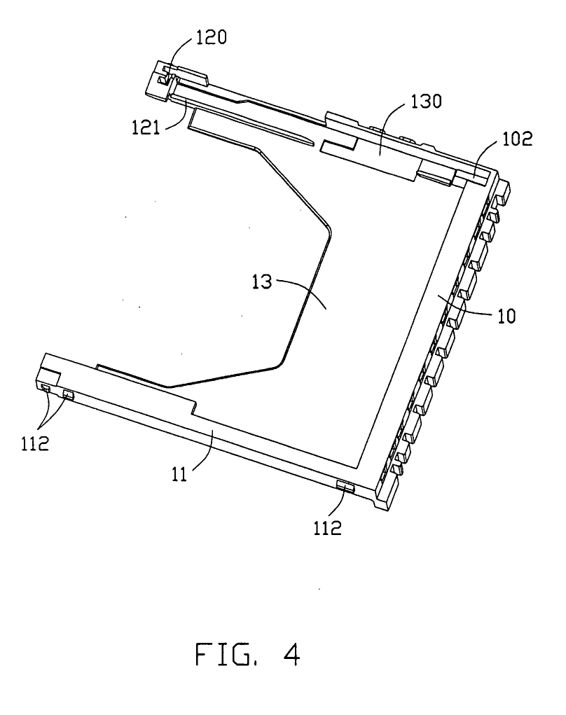

Referring to FIGS. 1-4, the insulating housing 10 is approximately frame configuration. The insulating housing 1 comprises a front wall 10, a pair of opposite right and left sidewalls 11, 12 and a bottom wall 13, which commonly define a card receiving space 15 for accommodating the card 7 and a card insertion/ejecting direction. The front wall 10 is formed with a plurality of contact channels 101 extending through the front wall 10 in a front-to-back direction and a step 103 for supporting the insulating housing 1. The opposite side walls 11, 12 are respectively formed with protruding blocks 112, 122 on outsides surface thereof for engaging with the shell 4. The left sidewall 12 is formed with a recess 123 on an outside surface thereof with two pins 124 in the recess 123, a gap 120 in a rear end thereof and a pole 102 in a front end thereof. The bottom wall 13 is formed with a rib 121 adjacent and parallel to the sidewall 12 to define a slot (not labeled) for receiving the ejector 3 and a through hole 130 for receiving the locking member 5. The through hole 130 is in front of the slot on the bottom wall 13 in a linear direction and corresponding to the recess 123 of the sidewall 12.

The contacts 2 include a plurality of signal contacts 21 for electrically connecting with electrical pads (not shown) of the card 7, a write-protect contact 22 for identifying IC card write inhibit and a detecting contact 23 detecting the insertion of the IC card. All of the contacts 2 are retained to corresponding contact channels 101 of the front wall 10 of the insulating housing 1. The signal contacts 21 have a common configuration, each of the signal contacts 21 comprises a holding portion 210 retained in corresponding contact channel 101, a contacting portion 211 rearwardly extending from the holding portion 210 and into the card receiving space 15 for electrically contacting with the card 7 and a soldering portion 212 downwardly extending from the holding portion 210 and out of the insulating housing 1 to be soldered to the print circuit board.

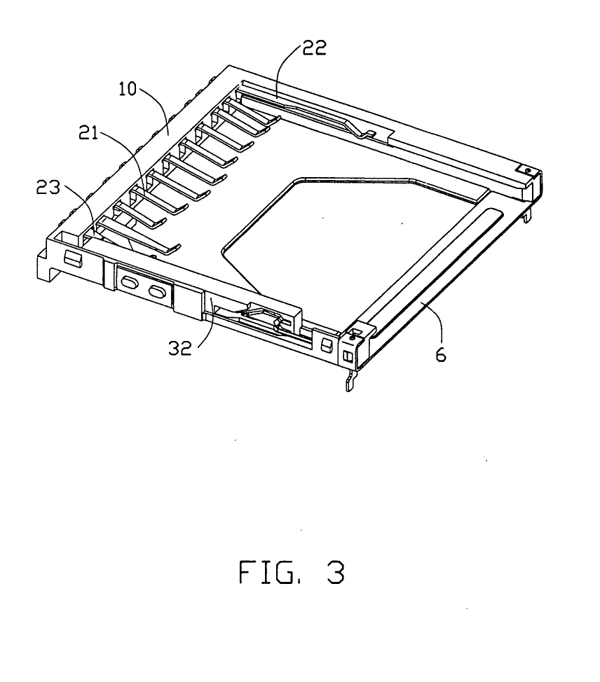

Both of the write-protect contact 22 and the detecting contact 23 are in simple strip-liked shapes as the signal contacts 21 and able to assembled to the insulating housing 1 together with the signal contacts 21 in one assembly process. The write-protect contact 22 has a retaining portion 222 retained in the contact channel 101, a spring portion 220 extending rearwardly from the retaining portion 222 and into the card receiving space 15, a contacting portion 221 at the rear end of the spring portion 220, a mounting portion 223 extending from the retaining portion 222 and beyond the insulating housing 1 for mounting to the print circuit board. For a configuration of the detecting contact 23 is essentially same as that of the write-protect contact 22, here will not say more than is needed, the detecting contact 23 comprises a retaining porting 232, a spring portion 230, a contacting portion 231 and a mounting portion 233. FIG. 3 shows a situation that the contacts 2 are assembled to the insulating housing 1, we can see the write-protect contact 22 has the longest length.

Referring to FIGS. 1-2, the shell 4 is stamped from a metal sheet and covers on the insulating housing 1. The shell 4 comprises a top wall 40, a plurality of side pieces 41, 42, 43, 44 extending downwardly from lateral sides of the top wall 40 and a mounting piece 45 extending downwardly from a left part of a front edge of the top wall 40 to the print circuit board (not shown). The side pieces 41, 42, 43 are in the left side of the shell 4, the side piece 44 is in the right, and the side pieces 42, 43 define latching hole 420, 430, the side piece 43 further has a pressing arm 431 for pressing the ejector 3. The top wall 40 is provided with a pair of pressing fingers 401 for downwardly pressing the card 7 inserted into the card connector 100 to get a well connecting between the card 7 and the signal contacts 21, two guiding pieces 402 on a left edge thereof for guiding the ejector 3, two elastic slices 403, 404 disposed respectively correspondingly to the write-protect contact 22 and the detecting contact 23. When the shell 4 assembles to the insulating housing 1, the latching holes 420, 430 of the shell 4 receive the protruding blocks 112, 122 of the insulating housing 1.

When the shell 4 covers the insulating housing 1, the mounting piece 45 is used to connect with a grounding track on the print circuit board (not shown) for grounding the write-protect contact 22 and the detecting contact 23. During the card 7 inserting into the card connector 100, a top surface of the card 7 presses against the spring portion 220 of the write-protect contact 22. The spring portion 220 of the write-protect contact 22, together with the contact portion 221, moves upwardly, and the contact portion 221 comes into connecting with the elastic slice 404 on the top wall 40 of the shell 4 for facilitating write-protect of the electrical card 7. When the card 7 is fully inserted into the card connector 100 and arrives a final position, the top surface of the card 7 presses against the spring portion 230 of the detecting contact 23. The spring portion 230, together with the contact portion 231, moves upwardly, and the contact portion 231 comes into connecting with the elastic slice 403 on the top wall 40 of the shell 4 for detecting the insertion of the electrical card 7. According to a position of a write-protect block 71 moveable in a recess 70 defined on a side of the card 7, the spring portion 220 with the contact portion 220 may keep engaging with the elastic slice 404 of the shell 4 against the write-protect block 71 or insert the recess 70 of the card, and disengage with the corresponding 221 of the elastic slice 404. The shell 4 is further formed with a plurality of through gaps 405 according to the signal contacts 21.

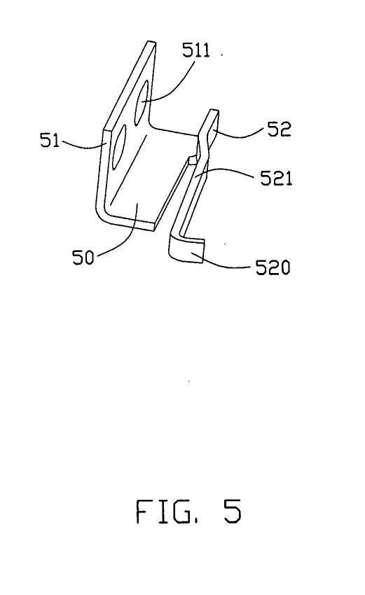

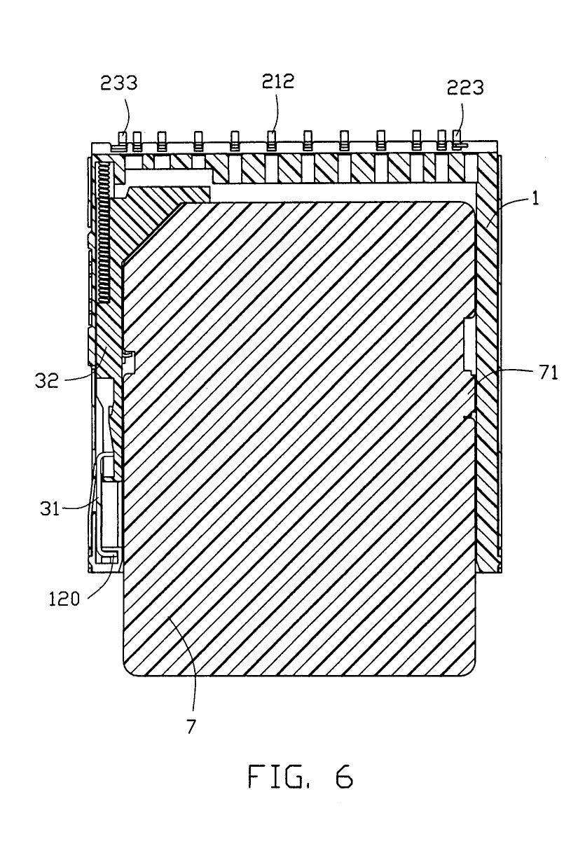

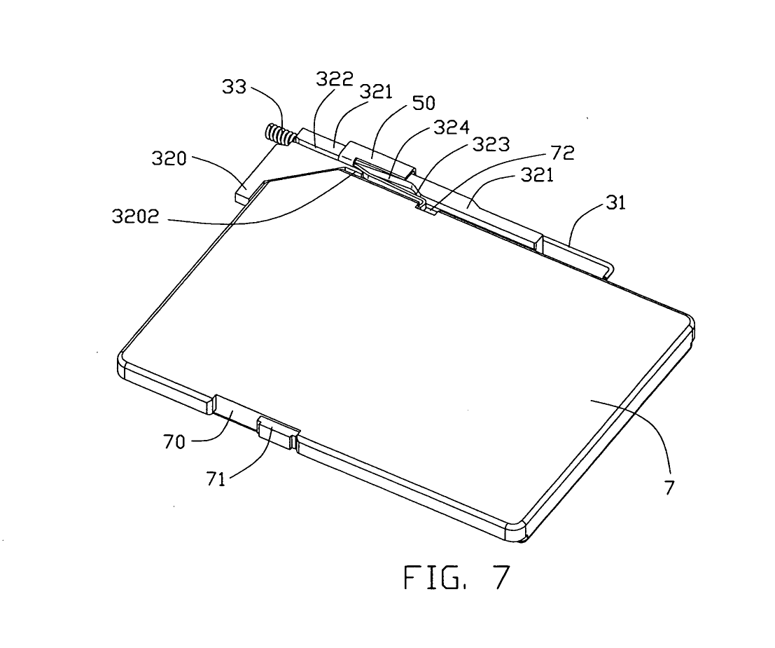

Referring to FIG. 2 and FIGS. 5-7, we will describe the ejector 3 hereafter, the ejector 3 is disposed into the slot (not labeled) of the insulating housing 1 and used for ejecting the card 7 out of the card connector 100. The ejector 3 comprises a pin member 31, a slider 32 with a heart groove 325 and a spring 33. The pin member 31 and the heart groove 325 are referred as a holding equipment and can hold the slider 32 in the final position where the card 7 is electrically connected with the card connector 100 and can release the slider 32 when ejecting the card 7 by pushing the card 7 forwardly again.

The slider 32 is approximate in an L-shape and has a base 321 and an ejecting portion 320 for ejecting the card 7, the base 321 defines a groove 322 and a room 324 recessed from an inner side surface of the base 321 and communicating with the groove 322 on a bottom surface thereof. The room 324 has an incline 323 on a rear portion thereof and approaching to the inner side surface of the base 321. The slider 32 further has a restrictive wall 3202 to limit the locking member 5.

The locking member 5 has a horizontal body 50, a vertical retaining portion 51 and an upright portion 52 in two opposed side of the retaining portion 51. The upright portion 52 comprises an elastic arm 521 and a latching portion 520 at a free end of the elastic arm 521. When the locking member 5 is assembled to the insulating housing 1, the body 50 is received in the through hole 130, the retaining portion 51 is placed in and retained to the recess 123 of the sidewall 12 by the holes 511 receiving and jointed with the pins 124 of the sidewall 12 in a holt-melt process, the latching portion 520 of the upright portion 52 extends into the card receiving space 15 if the ejector 3 is not assembled to the insulating housing 1. After the ejector 3 is assembled in the insulating housing 1 and at an original position, the upright portion 52 of the locking member 5 is positioned in the groove 322 and the room 324 defined on the bottom surface of the slider 32, the elastic arm 521 is limited by the restrictive wall 3202 with the latching portion 520 positioning in the room 324 near the incline 323.

When the slider 32 moves forwardly along the card insertion direction together with the card 7, the elastic arm 521 moves rearwardly along the groove 322 relative to the slider 32, the restrictive wall 3202 of the slider 32 releases the limit to the elastic arm 521, the elastic arm 521 rotates inwardly and the latching portion 520 leaves the room 324 and inserts into a notch 70 defined on a side of the card 7. Following the slider 32 sequentially moving, the latching portion 520 further slides along the inner side surface of the slider 32 till the slider 32 arrives and is locked in the final position. Then the latching portion 520 locks the card 7 to the insulating housing 1 and prevents the card 7 from pulling out of the card connector 100 by mistake. When ejecting the card 7, the slider 32 is released and moves rearwardly along the card ejecting direction, the latching portion 520 will return into the room 324 of the slider 32, and then the locking of the card 7 is released.

Referring to FIG. 2, the card connector 100 further has the supporting board 6 assembled to an insertion port (not labeled) of the card connector 100 to support the card 7. The supporting board 6 has a main body 60, two legs 61 extending from opposed ends of the main body 61 and two mounting portions 62 above the legs 61, each mounting portion 62 has an aperture 621 for engaging with the protruding blocks 112, 122 of the insulating housing 1.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A card connector adapted for receiving a card, comprising:
an insulating housing defining a card receiving space;
a plurality of signal contacts retained in the insulating housing for electrically connecting with the card;
a shell shielding the insulating housing and having a top wall;
a switch contact having a retaining portion secured in the housing, a spring portion extending from the retaining portion into the card receiving space, a contacting portion, the spring portion with the contacting portion being pressed upwardly by the card inserted into the card receiving space, and the contacting portion electrically connecting with the top wall of the shell.

2. The electrical card connector according to claim 1, wherein the insulating housing has a front wall defined a plurality of contact channels, the switch contact and the signal contacts are assembled to corresponding contact channels of the insulating housing.

3. The electrical card connector according to claim 2, wherein a shape of the switch contact is essential same as that of the signal contact.

4. The electrical card connector according to claim 3, wherein the shell has a mounting piece for being soldered to a print circuit board.

5. The electrical card connector according to claim 3, wherein the switch contact is a write-protect contact adapted for identifying the card write inhibit, the top wall of the shell has an elastic slice for contacting with the contacting portion of the switch contact.

6. The electrical card connector according to claim 5, further includes another detecting contact adapted for detecting the insertion of the IC card, the detecting has a retaining portion secured to the insulating housing and a spring portion with a contact portion extending into the card receiving space, the spring portion with the contact portion is pressed upwardly by the card inserted into the card receiving space, and the contacting portion electrically contact with another elastic slice correspondingly formed on the top wall of the shell.

7. The electrical card connector according to claim 6, wherein a shape of the detecting contact is essential same as that of the signal contacts, the detecting contact is able to fix to one of the contact channels of the front wall together with the signal contacts and the switch contact.

8. An electrical card connector comprising:
an insulative housing;
a metallic shell attached to the housing and cooperating with the housing to define a card receiving cavity;
a plurality of contacts retained in the housing with contacting section extending into the card receiving cavity;
a switch contact retained by the housing and defining a card engagement section extending into the card receiving cavity and a contacting section engageable with the shell to result in electrical connection or disconnection therebetween.

9. The electrical card connector as claimed in claim 8, wherein the shell defines a deflectable tang engageable with the contacting section.

10. The electrical card connector as claimed in claim 8, wherein the contacting section and the tang move along a same direction when engaged with each other.

11. An electrical card connector assembly comprising:
an electronic card;
an insulative housing;
a metallic shell attached to the housing and cooperating with the housing to define a card receiving cavity;
a plurality of contacts retained in the housing with contacting section extending into the card receiving cavity;
a switch contact retained by the housing and defining a card engagement section extending into the card receiving cavity and a contacting section engageable with the shell to result in electrical connection or disconnection therebetween, depending upon whether the card is positioned in the card receiving cavity or not.

12. The electrical card connector assembly as claimed in claim 11, wherein the contacting section engages the shell when the card is received in the card receiving cavity.

13. The electrical card connector assembly as claimed in claim 11, wherein the shell defines a resilient tang engaged with the contacting section when the card is received in the card receiving cavity.

14. The electrical card connector assembly as claimed in claim 13, wherein both said contacting section and said resilient tang are moved in a same direction away form the card receiving cavity when the card is received in the card receiving cavity.
